(19) United States
(12) Patent Application Publication
(10) Pub. No.: US 2013/0254568 A1
(43) Pub. Date: Sep. 26, 2013

(54) POWER SUPPLY DEVICE FOR SERVER

(71) Applicants: Kuei-Chih Hou, New Taipei (TW); Yu-Chi Tsai, New Taipei (TW)

(72) Inventors: Kuei-Chih Hou, New Taipei (TW); Yu-Chi Tsai, New Taipei (TW)

(21) Appl. No.: 13/682,601

(22) Filed: Nov. 20, 2012

(30) Foreign Application Priority Data
Mar. 26, 2012 (TW) 101205453

(51) Int. Cl. G06F 1/26

(52) U.S. Cl. CPC G06F 1/26
USPC 713/310

(57) ABSTRACT

A power supply device supplies power to a plurality of servers includes a power distribution unit (PDU) electronically connected to an alternating current (AC) power source, a plurality of power supply units (PSU) corresponding to the plurality of servers, and a stand-by power source connected to the plurality of PSUs. Each PSU connects the PDU to a corresponding server, converts alternating current from the PDU into direct current (DC) and provides the DC to the corresponding server. The stand-by power source includes a plurality of storage units. Each storage unit is located between two adjacent servers and is electronically connected between a corresponding server and a corresponding PSU. Each PSU charges a storage unit. If the AC power source stops providing AC power to the PDU, the PDU sends a control signal to the storage unit to allow the storage unit to supply DC power to the corresponding server.

### BACKGROUND

1. Technical Field

The disclosure generally relates to power supply devices, and particularly to a power supply device for servers.

2. Description of the Related Art

Power distribution units (PDU) have long been utilized to distribute alternating current (AC) power to a plurality of servers. A power adaptor of the server converts the alternating current into direct current (DC) to power the server. An uninterruptible power supply (UPS) can also be provided to supply alternating current to the PDU during a power outage. However, the UPS takes up server rack space.

Therefore, there is room for improvement within the art.

### BRIEF DESCRIPTION OF THE DRAWINGS

Many aspects of an exemplary power supply device can be better understood with reference to the following drawings. The components in the drawings are not necessarily drawn to scale, the emphasis instead being placed upon clearly illustrating the principles of the exemplary power supply device. Moreover, in the drawings, like reference numerals designate corresponding parts throughout the several views. Wherever possible, the same reference numbers are used throughout the drawings to refer to the same or like elements of an embodiment.

FIG. 1 is a block diagram of a power supply device for a plurality of servers, according to an exemplary embodiment.

FIG. 2 is a block diagram of a storage unit, a power distribution unit, a power supply unit and a server shown in FIG. 1.

FIG. 3 is a schematic, assembled view of the storage units and the servers shown in FIG. 1.

### DETAILED DESCRIPTION

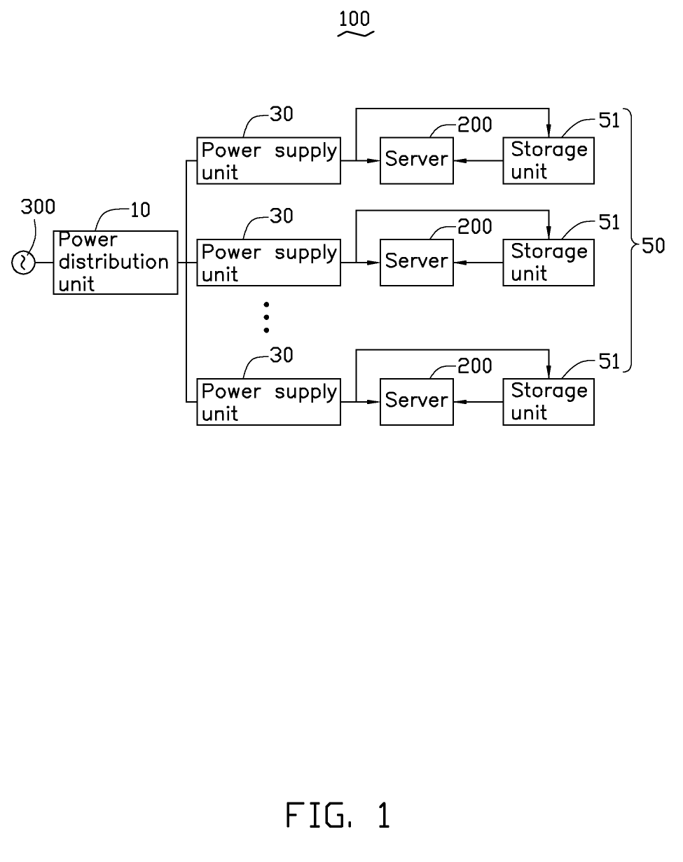

FIG. 1 shows an exemplary embodiment of a power supply device 100. The power supply device 100 supplies power to a plurality of servers 200 located in a server rack (not shown). The power supply device 100 includes a power distribution units (PDU) 10, a plurality of power supply units (PSU) 30 corresponding to the plurality of servers 200, and a stand-by power source 50 connected to the plurality of PSUs 30. The PDU 10 is electronically connected to an external AC power source 300, and distributes AC power to the plurality of PSUs 30. Each PSU 30 converts alternating current from the PDU 10 into direct current and provides the direct current to a corresponding server 200. In the embodiment, the PDU 10 is a socket, and the PSU 30 is an AC/DC adaptor.

The stand-by power source 50 includes a plurality of storage units 51 corresponding to the plurality of servers 200. Each storage unit 51 is located adjacent to a corresponding server 200 and is electronically connected between the corresponding server 200 and the corresponding PSU 30.

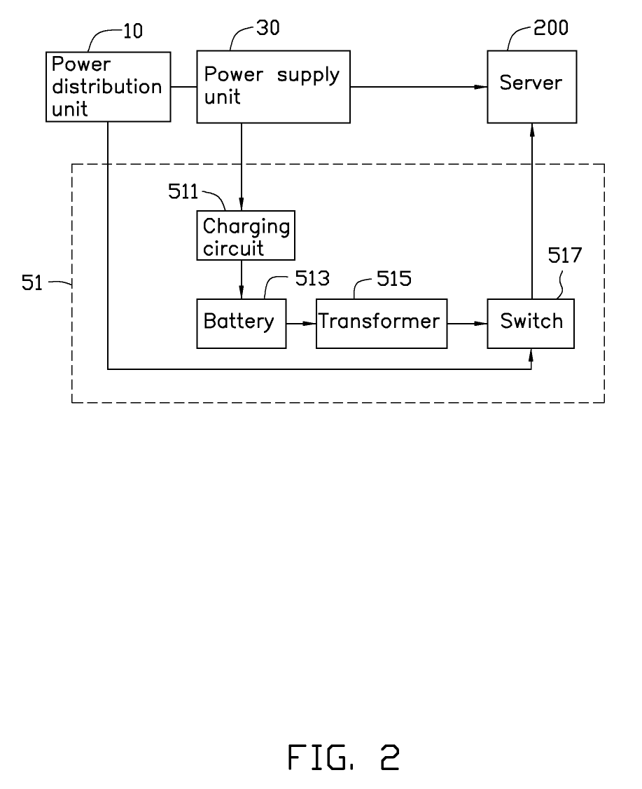

FIG. 2 shows that each storage unit 51 includes a charging circuit 511, a battery 513, a transformer 515, and a switch 517. The charging circuit 511 is electronically connected between the PSU 30 and the battery 513. The battery 513 is electronically connected to the switch 517 through the transformer 515. The switch 517 is electronically connected to the PDU 10 and the server 200.

The charging circuit 511 converts an output voltage from the PSU 30 into a rated voltage of the battery 513, and charges the battery 513. The battery 513 can be one of lithium batteries, nickel-metal hydride batteries, nickel-cadmium batteries, and lead-acid batteries.

The transformer 515 is a DC to DC transformer. The transformer 515 converts an output voltage from the battery 513 into a rated voltage of the server 200. The rated voltage of the server 200 is provided to the server 200 through the switch 517. In this embodiment, the switch 517 is a transistor and is switched on or off under the control of the PDU 10.

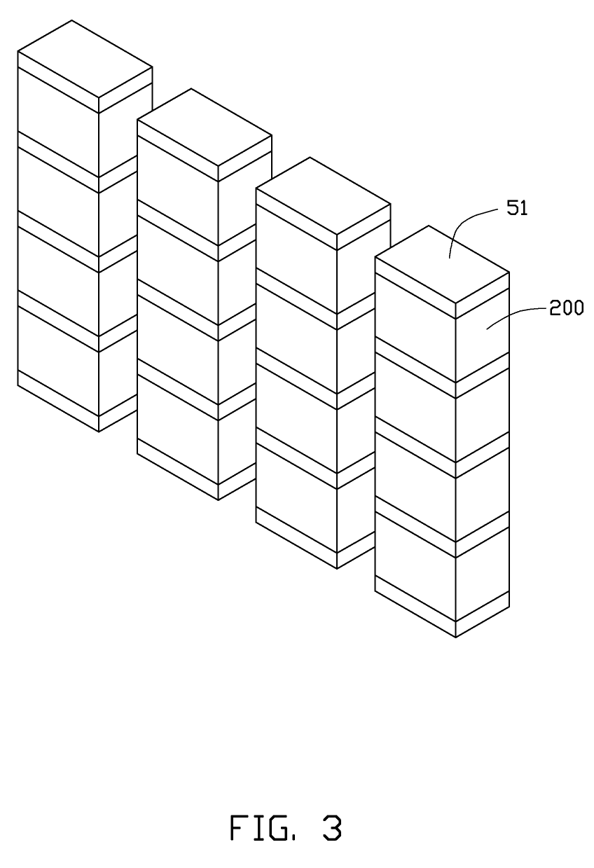

FIG. 3, in this embodiment, shows that each storage unit 51 may be located on or under a corresponding server 200 and be located between two adjacent servers 200. A working process of the power supply device 100 may include the following steps: the external AC power source 300 provides AC power to the PDU 10. The PDU 10 distributes the AC power to the plurality of PSU 30. Each PSU 30 converts alternating current from the PDU 10 into direct current and provides the direct current to a corresponding server 200, and charges the battery 513 through the charging circuit 511. If the external AC power source 300 stops providing AC power to the PDU 10, the PDU 10 stops working and sends a control signal to the switch 517. The switch 517 receives the control signal and is closed according to the control signal. The battery 513 outputs an output voltage to the transformer 515, and the transformer 515 converts the output voltage into a rated voltage of the server 200. The transformer 515 provides the rated voltage to the server 200 through the switch 517.

In this embodiment, the stand-by power source 50 provides DC power to the server 200 with almost no power conversion loss. The stand-by power source 50 includes a plurality of storage units 51, and each storage unit 51 may be located on or under a corresponding server 200. The storage unit 51 takes up space between two adjacent servers, thus, the server rack does not need a dedicated space to receive the stand-by power source 50.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A power supply device that supplies power to a plurality of servers, the power supply device comprising:
a power distribution unit (PDU) electronically connected to an external alternating current (AC) power source;
a plurality of power supply units (PSU) corresponding to the plurality of servers, each PSU connecting the PDU to a corresponding server, converting alternating current from the PDU into direct current (DC) and providing the direct current to the corresponding server; and
a stand-by power source electronically connected to the plurality of PSUs;
wherein the stand-by power source comprises a plurality of storage units corresponding to the plurality of servers; each storage unit located between two adjacent servers and electronically connected between the corresponding server and a corresponding PSU; each PSU charges a corresponding storage unit; if the external AC power source stops providing AC power to the PDU, the PDU sends a control signal to the storage unit to allow the storage unit to supply DC power to the corresponding server.

2. The power supply device as claimed in claim 1, wherein each storage unit comprises a battery and a switch; the battery is electronically connected between a corresponding PSU and the switch, the switch is electronically connected to the PDU and the corresponding server.

3. The power supply device as claimed in claim 2, wherein each storage unit further comprises a charging circuit and a transformer, the charging circuit is electronically connected between the corresponding PSU and the battery; the battery is electronically connected to the switch through the transformer.

4. The power supply device as claimed in claim 3, wherein the battery is one of lithium batteries, nickel-metal hydride batteries, nickel-cadmium batteries, and lead-acid batteries.

5. The power supply device as claimed in claim 3, wherein the switch is a transistor and is switched on or off under the control of the PDU.

6. The power supply device as claimed in claim 3, wherein the transformer is a DC to DC transformer.

7. A power supply device that supplies power to a plurality of servers, the power supply device comprising:
a power distribution unit (PDU) electronically connected to an external alternating current (AC) power source;
a plurality of power supply units (PSU) corresponding to the plurality of servers, each PSU connecting the PDU to a corresponding server, converting alternating current from the PDU into direct current (DC) and providing the direct current to the corresponding server; and
a stand-by power source electronically connected to the plurality of PSUs, the stand-by power source comprising a plurality of storage units corresponding to the plurality of servers, each storage unit comprising a battery and a switch; the battery is electronically connected between a corresponding PSU and the switch, the switch is electronically connected to the PDU and the corresponding server;
wherein each storage unit is located between two adjacent servers; each PSU charges a corresponding battery; if the external AC power source stops providing AC power to the PDU, the PDU sends a control signal to close the switch to allow the battery to supply DC power to the corresponding server.

8. The power supply device as claimed in claim 7, wherein each storage unit further comprises a charging circuit and a transformer, the charging circuit is electronically connected between the corresponding PSU and the battery; the battery is electronically connected to the switch through the transformer.

9. The power supply device as claimed in claim 8, wherein the battery is one of lithium batteries, nickel-metal hydride batteries, nickel-cadmium batteries, and lead-acid batteries.

10. The power supply device as claimed in claim 8, wherein the switch is a transistor and is switched on or off under the control of the PDU.

11. The power supply device as claimed in claim 8, wherein the transformer is a DC to DC transformer.
